(19) United States
(12) Patent Application Publication
(10) Pub. No.: US 2010/0059442 A1
(43) Pub. Date: Mar. 11, 2010

(54) METHOD AND SYSTEM FOR SEPARATING ANALYTES

(75) Inventors: David Nurok, Indianapolis, IN (US); Allyson L. Novotny, Indianapolis, IN (US); Timothy Stachowiak, Oakland, CA (US); Frantisek Svec, Alameda, CA (US)

Correspondence Address: BARNES & THORNBURG LLP, 11 SOUTH MERIDIAN, INDIANAPOLIS, IN, 46204, US

(73) Assignee: The Regents of the University of California

(21) Appl. No.: 12/514,678

(22) PCT Filed: Nov. 16, 2007
(86) PCT No.: PCT/US07/84940

§ 371 Date: May 21, 2009

Related U.S. Application Data
(60) Provisional application No. 60/859,720, filed on Nov. 17, 2006.

(51) Int. Cl. B01D 15/08

(52) U.S. Cl. 210/656; 210/198.2

(57) ABSTRACT

A method and device for performing chromatography includes placing a monolithic polymer layer in contact with a liquid mobile phase. The monolithic polymer layer may be neutral, positively charged, or negatively charged. A first electrode and second electrode are coupled to the monolithic polymer layer. An electrical potential is created between the first electrode and the second electrode. In some embodiments, the monolithic polymer layer may be placed in a sealed chamber, which may have a pressure greater than atmospheric pressure. Additionally, in some embodiments, the mobile phase is advanced through the monolithic polymer layer via one of a number of forced flow techniques.

This patent application claims priority to and the benefit of U.S. Provisional Patent Application Ser. No. 60/859,720 entitled “Method and Apparatus For Separating Analytes On An Uncharged Monolith Layer,” which was filed on Nov. 17, 2006 by David Nurok et al., the entirety of each of which is expressly incorporated herein by reference.

### CROSS-REFERENCE TO RELATED U.S. PATENT APPLICATION

Cross-reference is made to U.S. Utility Pat. No. 6,303,029 entitled “Arrangement And Method For Performing Chromatography,” which was filed on Oct. 25, 1999 by David Nurok et al, to U.S. Utility Pat. No. 6,610,202 entitled “Arrangement And Method For Performing Chromatography,” which was filed on Aug. 28, 2001 by David Nurok et al., to U.S. Utility Pat. No. 7,279,105 entitled “Arrangement And Method For Performing Chromatography,” which was filed on Aug. 22, 2003 by David Nurok et al, and U.S. Utility patent application Ser. No. 10/560,869 entitled “Method And Apparatus For Performing Planar Electrochromatography At Elevated Pressure,” which was filed on Dec. 14, 2005 by David Nurok et al., the entirety of each of which is expressly incorporated herein by reference.

### TECHNICAL FIELD

The present disclosure relates generally to systems and methods for performing chromatography.

### BACKGROUND

Chromatography is a technique used for separating complex mixtures into their components. Chromatography can be described as a separation process based on difference in the rate at which the components of a mixture move through a chromatographic bed. During this process, the analytes partition between a moving phase called the mobile phase and a non-moving phase called the stationary phase. The chromatographic bed will typically include a plurality of porous, micro-porous, or non-porous particles. In some chromatographic systems, such as High Performance Liquid Chromatography (HPLC), the chromatographic bed may be packed into the interior of a column. Conversely, in other chromatographic systems, such as Thin Layer Chromatography (TLC) and Overpressured Layer Chromatography (OPLC), the chromatographic bed may be dispersed on a sample plate.

### SUMMARY

According to one aspect, a method for performing chromatography may include placing a monolithic polymer layer in contact with a liquid mobile phase. The monolithic polymer layer may be neutral, positively charged, or negatively charged. For example, in some embodiments, a first end and a second end of the polymer monolithic layer may be placed in contact with the liquid mobile phase.

The method may also include coupling a first electrode to the monolithic polymer layer. Additionally, the method may include coupling a second electrode to the monolithic polymer layer. For example, in some embodiments, the first electrode and/or the second electrode may be placed in contact with the monolithic polymer layer and/or the liquid mobile phase.

The method may further include creating an electrical potential between the first electrode and the second electrode. Creating an electrical potential between the first electrode and the second electrode may cause the liquid mobile phase to be advanced through a charged monolithic polymer layer. For example, the liquid mobile phase may be advanced through the charged monolithic polymer layer via electroosmotic flow. In embodiments wherein the monolithic polymer layer is neutral, creating an electrical potential between the first electrode and the second electrode may cause an analyte positioned in the monolithic polymer layer to advance through the monolithic polymer layer via electrophoresis.

In some embodiments, the method may include placing the polymer monolithic layer in a sealed chamber. Additionally, the method may include increasing the pressure inside the sealed chamber relative to the pressure outside the sealed chamber. Further, the method may include maintaining the pressure inside the sealed chamber at a pressure above atmospheric pressure. Additionally or alternatively, the method may include exerting an amount of pressure on the monolithic polymer layer greater than atmospheric pressure. The method may also include maintaining the temperature of the monolithic polymer layer at a predetermined temperature.

According to another aspect, a method for performing chromatography may include placing a monolithic polymer layer in contact with a liquid mobile phase. The monolithic polymer layer may be neutral, positively charged, or negatively charged. The method may also include advancing the liquid mobile phase through the monolithic polymer layer via a forced flow technique. One of a number of different forced flow techniques may be used such as, for example, rotational planar chromatography, overpressured layer chromatography, planar electrochromatography, or pressurized planar electrochromatography.

According to yet another aspect, a chromatographic bed for use in chromatography may include a monolithic polymer layer. The monolithic polymer layer may include a plurality of ionizable functionalities. Additionally, the monolithic polymer layer may be positively or negatively charged.

### BRIEF DESCRIPTION OF THE DRAWINGS

The detailed description particularly refers to the following figures, in which:

FIG. 1 is a perspective view of a chromatography sample plate;

FIG. 2 is a simplified flowchart of an algorithm for preparing the sample plate of FIG. 1;

FIG. 3 is an exploded perspective view of a chromatography sample plate assembly.

FIG. 4 is a diagrammatic view of one embodiment of a chromatography apparatus for use with the chromatography sample plate of FIG. 1;

FIG. 5 is diagrammatic representation of a plug flow profile of a mobile phase; and

FIG. 6 is a diagrammatic representation of a laminar flow profile of a mobile phase.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives falling within the spirit and scope of the invention as defined by the appended claims.

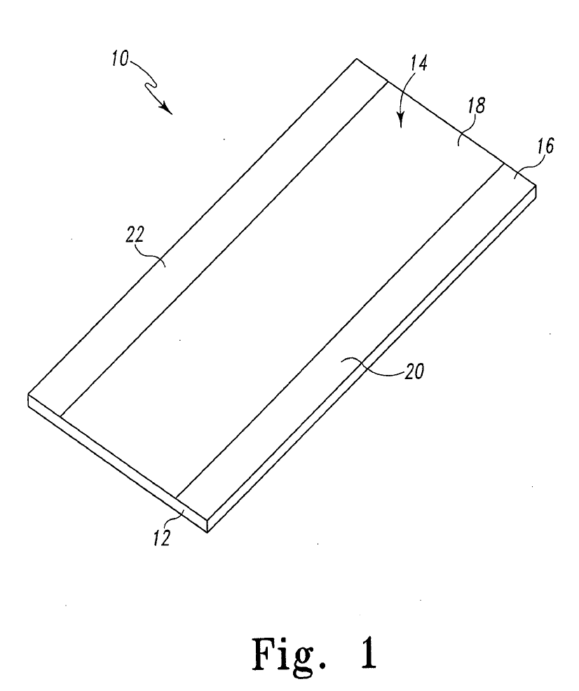

Referring to FIG. 1, in one embodiment, a chromatographic sample plate 10 includes a support substrate 12 and a chromatographic bed 14 disposed on or otherwise adhered to a front side 16 of the substrate 12. The illustrative sample support substrate 12 is formed from a glass material, but may be formed from other materials in other embodiments such as quartz, silicon, plastic, or other material.

The chromatographic bed 14 is embodied as a monolithic polymer layer 18, which may be neutral, positively charged, or negatively charged. As discussed in more detail below, the monolithic polymer layer 18 is formed by polymerization mixtures. The layer 18 is formed to have a predetermined thickness based on, for example, the particular application or apparatus with which the monolithic polymer layer 18 will be used. For example, the monolithic polymer layer 18 may be formed to have a thickness of about ten micrometers to about one centimeter in some embodiments. For example, in one particular embodiment, the layer 18 may have a thickness of about 50 micrometers to about 250 micrometers. However, in other embodiments, monolithic polymer layers 18 having other thicknesses may be used. Additionally, the monolithic polymer layer 18 is fabricated to have a particular porosity, which may be adjusted to produce different chromatographic characteristics. In one embodiment, the monolithic polymer layer 18 is formed to have a porosity of about 20% to about 80%. For example, in one particular embodiment, the monolithic polymer layer 18 has a porosity of about 80%.

The chromatographic plate 10 may be used for the analysis of analytes as discussed in more detail below. In particular, the chromatographic plate 10 may be used with chromatographic systems for the rapid separation of analytes by electrophoresis in embodiments wherein the monolithic polymer layer 18 is neutral or by electroosmotic flow in those embodiments wherein the monolithic polymer layer 18 is positively or negatively charged. Because of the planar format of the chromatographic sample plate 10, multiple samples can be separated simultaneously. Additionally, two-dimensional separations may be performed. In one particular embodiment, the monolithic polymer layer 18 may be used in the separation of proteins and peptides, but may be used in the separation of other charged or uncharged molecules in other embodiments.

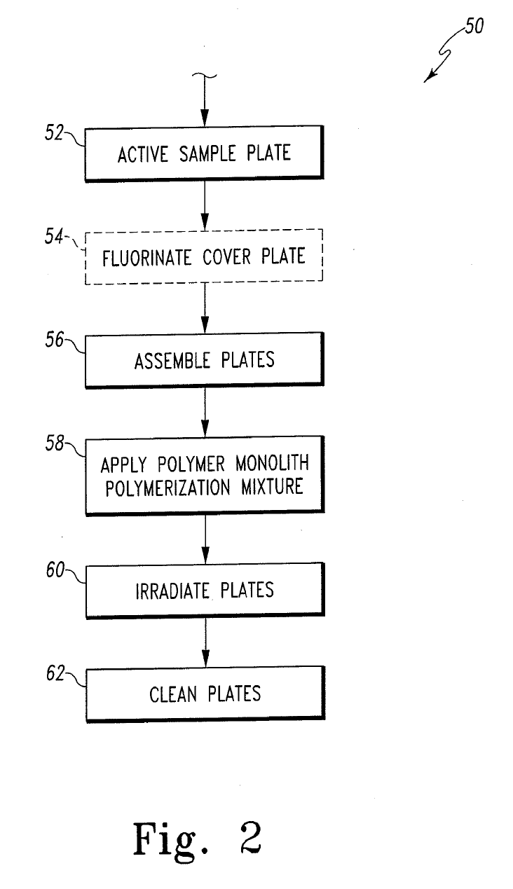

As illustrated in FIG. 2, the monolithic polymer layer 18 may be formed according to a process 50 for fabricating a chromatographic plate having a monolith polymer layer chromatographic bed. The algorithm 50 begins with a process step 52 in which the glass support substrate 12 is activated. To do so, in one embodiment, the front side 16 of the substrate 12 is surface-modified with 3-(trimethoxysilyl)propyl methacrylate to enable covalent attachment of the monolithic polymer layer 18 to the front side 16 of the substrate 12 through the resulting pendent vinyl groups. For example, in one particular embodiment, the sample support substrate 12 was initially rinsed with acetone and water, soaked in a solution of 0.2 mol/L sodium hydroxide for about thirty minutes, and subsequently rinsed with water. The support substrate 12 was then soaked in 0.2 mol/L hydrochloric acid for about 30 minutes, followed by another rinsing with water. The support substrate 12 was then treated for about 60 minutes with a 20 wt % solution of 3-(trimethoxysilyl)propyl methacrylate in 95% ethanol with pH adjusted to 5 using acetic acid. The substrate 12 was subsequently washed with acetone, dried in a stream of nitrogen, and left at room temperature for about twenty-four hours.

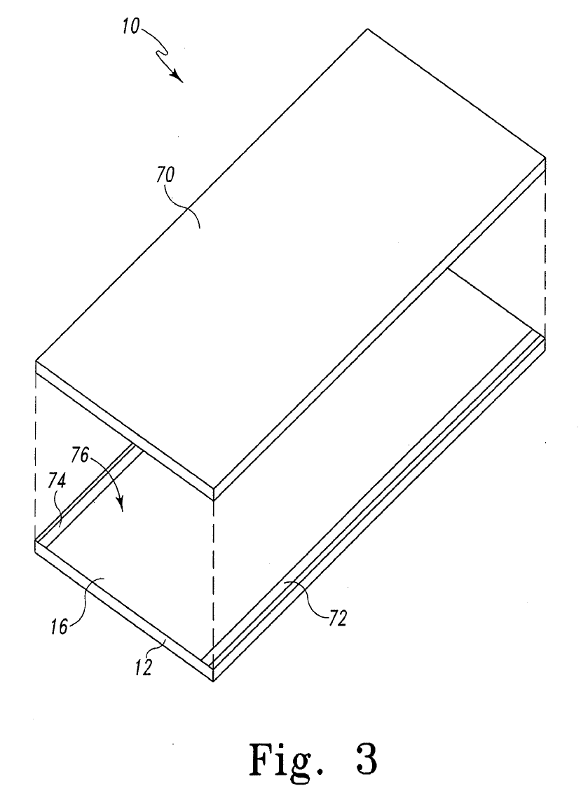

As discussed in more detail below, the creation of the monolithic polymer layer 18 is carried out within a cavity defined between the sample substrate 12 and a cover plate 70 (see FIG. 3), which may also be formed from a glass material. In one embodiment, the cover plate 70 may have a size and shape matching the sample substrate 12. In some embodiments, the cover plate 70 may be used without modification. However, in other embodiments, the cover plate 70 is surface-modified with a fluorosilane, such as (tridecafluoro-1,1,2,2-tetrahydrooctyl)-1-trichlorosilane, in process step 54. Fluorination of the cover plate 70 limits adhesion of the monolithic polymer layer 18 during fabrication and allows the cover plate to be removed more easily after polymerization without damaging the monolith layer 18.

In one particular embodiment, the cover plate 70 was fluorinated by initially rinsing the plate 70 with acetone and water. The cover plate 70 was then soaked in a solution of 0.2 mol/L sodium hydroxide for about thirty minutes and subsequently rinsed with water. Next, the cover plate was soaked in 0.2 mol/L hydrochloric acid for about thirty minutes, followed by another water rinse. The cover plate 70 was then dried with a stream of nitrogen. The cover plate 70 and a small receptacle containing about 0.1 milliliters of fluorosilane, such as (tridecafluoro-1,1,2,2-tetrahydrooctyl)-1-trichlorosilane, were placed in a vacuum desiccator. The pressure within the desiccator was reduced to about 20 mbar. The vacuum chamber was then sealed for approximately two hours. After this time, the vacuum was released and the cover plate 70 were left at room temperature for 24 h.

In process step 56, the sample plate 10 and cover plate 70 are assembled. Two thin strips 72, 74 (see FIG. 3) of material, such as a Teflon film, are positioned between the sample plate 10 and the cover plate 70 and near the outer edges of the plates 10, 70. The plates 10, 70 and the strips 72, 74 define a cavity 76 therebetween. The height of the cavity 76 is determined by the thickness of the two strips 72, 74, which may be embodied to have one of a number of different thicknesses. The distance between the two strips 72, 74 determines the width of the cavity 76. It should be appreciated that the dimensions of the cavity 76 define the dimensions of the monolithic polymer layer 18. Once the plates 10, 70 are so assembled, the plates 10, 70 and strips 72, 74 are secured together using clamps, clips, or the like.

In process step 58, the monolithic polymer layer 18 is created on the sample substrate 12. To do so, the cavity 76 defined between the sample substrate 12 and the cover plate 70 is filled with a polymerization mixture that has been purged with nitrogen for about 10 minutes. For example, a syringe having a small-diameter needle may be inserted into the cavity 76 or placed at the opening of the cavity 76 and the polymerization mixture may be injected into the cavity 76. However, in other embodiments, other methods of application may be used. The filling of the cavity 76 may be aided by capillary action, which helps to “pull” polymerization mixture into the cavity.

One of a number of different polymerization mixtures may be used to form the monolithic polymer layer 18. For example, in one particular embodiment, the polymerization mixture comprised 24 wt % butyl methacrylate (BuMA), 16 wt % ethylene dimethacrylate (EDMA), 9.6% 1,4-butanediol, 44.4% 1-propanol, 5.55% water, 0.45% methacryloyloxy)ethyl]trimethylammonium chloride (META) or 2-acrylamido-2-methyl-1-propanesulfonic acid (AMPS) depending on the desired polarity of the layer 18, and 1 wt % 2,2-dimethoxy-2-phenylacetophone (DMPA) (with respect to monomers). It should be appreciated that the monolithic polymer layer 18 includes ionizable functionalities in embodiments wherein a charged monolithic polymer layer 18 is desired. The ionizable functionalities may be embodied as any organic functional groups that may be ionized to establish a negative or positive charge in the monolithic polymer layer 18. For example, in embodiments wherein a positively charged polymer monolithic layer 18 is desired, [2-(methacryloyloxy)ethyl]trimethylammonium chloride (META) may be used. Alternatively, in embodiments wherein a negatively charged layer 18 is desired, 2-acrylamido-2-methyl-1-propanesulfonic acid (AMPS) may be used. However, in embodiments wherein a neutral polymer monolithic layer 18 is desired, poly(butyl methacrylate-co-ethylene dimethacrylate) may be used with no META, AMPS, or other ionizable functionalities added to the polymerization mixture. As such, it should be appreciated that neutral monolithic polymer layers and monolithic polymer layers having a positive charge or a negative charge may be fabricated using the process 50 illustrated in FIG. 2.

After the polymerization mixture has been placed into the cavity 76, the polymerization mixture is irradiated in process step 60. As discussed above, the plates 10, 70 may be formed from a glass, quartz, or similar material such that the plates 10, 70 provide an unobstructed path to facilitate full, uniform illumination during ultra-violet light exposure. In some embodiments, the ultra-violet light source may be configured to direct the ultra-violet light first through the substrate 12, which has been surface-modified with 3-(trimethoxysilyl)propyl methacrylate, in order to promote covalent attachment of the monolith layer to the glass sample plate 12.

In one particular embodiment, the assembly of the plates 10, 70 was placed under an ultra-violet light source and irradiated with ultra-violet light for about 10 minutes at a distance of about 30 centimeters from the ultra-violet light source. One of a number of different ultra-violet light sources may be used. In one particular embodiment, the ultra-violet light source was embodied as an OAI Model 30 deep IN collimated light source fitted with a 500 W HgXe lamp.

After the polymerization is complete, the plates 10, 70 are disassembled and the polymer monolithic layer 18 is cleaned to remove the porogenic solvents and any unreacted species. For example, in one particular embodiment, the sample substrate 12 including the layer 18 was rinsed with methanol and then soaked in methanol for about 24 hours.

It should be appreciated that the process 50 for fabricating the chromatographic sample plate 10 has been described above in regard to only one embodiment, which uses a number of particular chemicals, materials, and components. However, in other embodiments, other types of chemicals, materials, and/or components may be used. For example, some monomers that may be used in the preparation of the monolithic polymer layer 18 include butyl methacrylate (BuMA), ethylene dimethacrylate (EDMA), glycidyl methacrylate (GMA), 2-hydroxyethyl methacrylate (HEMA), 2-acrylamido-2-methyl-1-propanesulfonic acid (AMPS), and [2-(methacryloyloxy)ethyl]trimethylammonium chloride (META). Additionally, some porogenic solvents that may be used in the preparation of the monolithic polymer layer 18 include 1,4-butanediol, 1-propanol, water, decanol, dodecanol, and cyclohexanol. Some initiators may be used in the preparation of the monolithic polymer layer 18 include 2,2-dimethoxy-2-phenylacetophenone (DMPA) and azobisisobutyronitrile (AIBN). Further, some other chemicals and materials may be used in the preparation of the monolithic polymer layer 18 include 3-(trimethoxysilyl)propyl methacrylate (98%), (tridecafluoro-1,1,2,2-tetrahydrooctyl)-1-trichlorosilane, and FEP Type A Teflon film.

As discussed above, the chromatographic plate 10 having the monolithic polymer layer 18 disposed thereon may be used with chromatographic apparatuses for the rapid separation of analytes by electrophoresis or electrochromatography (i.e., by use of electroosmotic flow) depending on the particular application and/or apparatus with which the plate 10 is to be used. For example, an apparatus that may be used with the chromatographic plate 10 for performing rapid separation of analytes is described in U.S. Utility Pat. No. 6,303,029 entitled “Arrangement And Method For Performing Chromatography,” which was filed on Oct. 25, 1999 by David Nurok et al, in U.S. Utility Pat. No. 6,610,202 entitled “Arrangement And Method For Performing Chromatography,” which was filed on Aug. 28, 2001 by David Nurok et al., in U.S. Utility Pat. No. 7,279,105 entitled “Arrangement And Method For Performing Chromatography,” which was filed on Aug. 22, 2003 by David Nurok et al, and in U.S. Utility patent application Ser. No. 10/560,869 entitled “Method And Apparatus For Performing Planar Electrochromatography At Elevated Pressure,” which was filed on Dec. 14, 2005 by David Nurok et al., the entirety of each of which is expressly incorporated herein by reference. However, in other embodiments, other types of chromatographic apparatuses may be used.

In such apparatuses, a high voltage may be applied to the monolithic polymer layer 18, which allows for relatively rapid separation. If desired, a relatively constant temperature may also be maintained. In some embodiments, the apparatuses may include features or devices such as bladders, clips, or other devices for increasing the pressure within a sealed cavity containing the monolithic polymer layer 18 (e.g., a cavity created via use of a coverplate placed over the plate 10 with sealed edges) and/or increasing the pressure applied to the monolithic polymer layer 18. In other embodiments, atmospheric pressure may be used. For example, the monolithic polymer layer 18 may be open to the surrounding environment (e.g., a coverplate may not be used in some embodiments). Additionally, in some embodiments, the apparatuses may include features or device for maintaining the temperature of the monolithic polymer layer 18 at or near a predetermined or desired temperature.

The apparatuses may include a pool of mobile phase (in embodiments using electroosmotic flow) or liquid run buffer (in embodiments using electrophoretic mobility) at one end or both ends of the monolithic polymer layer 18. Note that the chemistry of a mobile phase and a run buffer may be similar or identical. In regard to electrophoresis, apparatuses that include a pool of run buffer (liquid) at both ends of the layer 18 may decrease the drying rate of the layer 18 relative to those apparatuses with only one end of the monolithic polymer layer 18 in contact with a pool of run buffer.

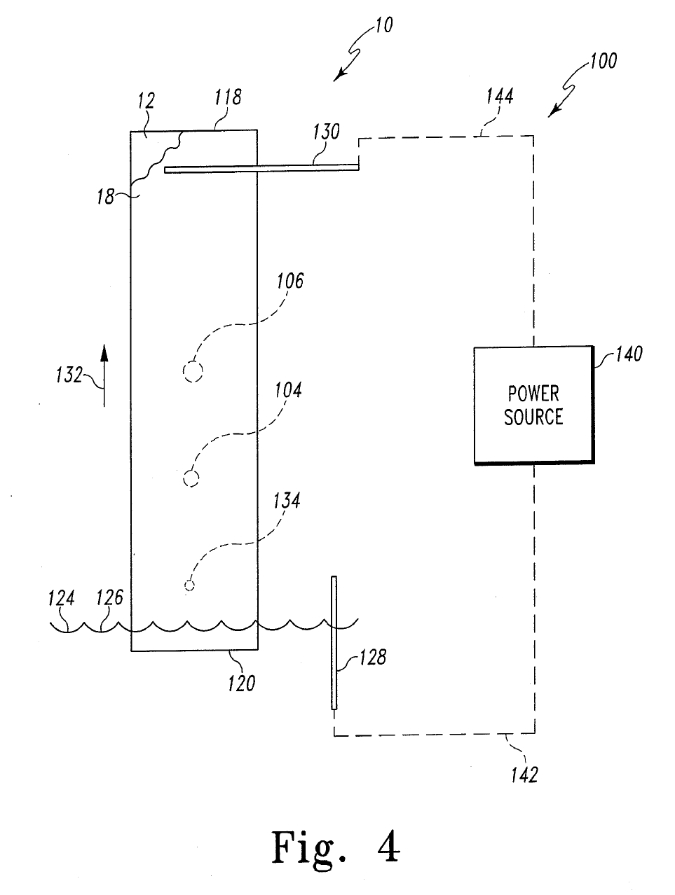

Referring now to FIG. 4, one illustrative embodiment of a chromatography arrangement 100 that may be used with the chromatographic sample plate 10 is illustrated. The chromatography arrangement 100 includes the chromatographic sample plate 10, an electrical power source 140, a first electrode 128 such as an anode, and a second electrode 130 such as a cathode. In addition to the polymer monolithic layer 18, the chromatography sample plate 10 includes a first end 118 and a second end 120. The arrangement 100 also includes a mobile phase 124 and a pair of electrical wires 142 and 144. Hereinafter first electrode 128 will be referred to as anode 128 and second electrode 130 will be referred to cathode 130.

It should be appreciated that the configuration of the arrangement 100 illustrated in FIG. 4 is but one of several possible configurations. For example, in other embodiments, the positions of the anode 128 and the cathode 130 may be swapped. In embodiments including a single mobile phase reservoir positioned at an end of the plate 10, the anode 128 and cathode 130 are positioned such that the mobile phase 124 propagates away from the reservoir of mobile phase 124. For example, in embodiments wherein the monolithic polymer layer 18 is positively charged, the anode 128 may be positioned at the end 118 (i.e., the end of the plate 10 not in contact with the mobile phase 124) and the cathode 130 may be positioned at the end 120 (i.e., the end of the plate 10 in contact with the mobile phase 124). Alternatively, in embodiments wherein the polymer layer 18 is negatively charged, the anode 128 may be positioned at the end 120 and the cathode may be positioned at the end 118 as shown in FIG. 4. Of course, in those embodiments including reservoirs of mobile phase 128 at each end 118, 120 of the plate 10, the anode 128 and cathode 130 may be positioned in any configuration in those embodiments using a charged (negatively or positively) monolithic polymer layer 18.

In embodiments wherein the monolithic polymer layer 18 is neutral, a mobile phase 124 reservoir is typically placed at each end 118, 120 of the plate 10 to reduce the likelihood that the layer 18 becomes overly dry. Alternatively, a single reservoir of the mobile phase 128 may be used at one end 118, 120 of the plate 10. In such embodiments, a wet wick material such as a wick material or cloth that has been wetted with the run buffer may be placed at the opposite end 118, 120 relative to the mobile phase 124. Regardless, in embodiments wherein the monolithic polymer layer 18 is neutral, the anode 128 and cathode 130 may be positioned in any configuration.

The arrangement 100 is described below in regard to illustrative embodiment in which a negatively charged monolithic polymer layer 18 is used. However, it should be appreciated that in other embodiments, the arrangement 100 may be used with monolithic polymer layers 18 that are positively charged or neutral with modifications as described above. For example, in embodiments wherein the monolithic polymer layer 18 is neutral, the apparatus 100 may include a reservoir of run buffer at each end 118, 120 of the chromatographic plate 10.

Referring now to one illustrative embodiment, the mobile phase 124 is embodied as a liquid. An example of a mobile phase which can be utilized in the present invention is 80% ethanol/water (v/v) with a final {3-[tris(hydroxymethyl amino]-1-propanesulfonic acid} (herein after referred to as TAPS) buffer concentration of about 0.001 millimoles to about 500 millimoles. For example, in one particular embodiment, a buffer concentration of about 1 millimoles to about 50 millimoles is used. TAPS is commercially available as catalogue number 21, 993-2 from the Aldrich Chemical Company, which is located in Milwaukee, Wis. However, in other embodiments, other types of mobile phases may be used such as, for example, 55% acetonitrile/water (v/v) and an acetate buffer, 40% acetonitrile/water (v/v) and a phosphate buffer, or the like.

The plate 10 may be pre-wetted by dipping the plate 10 in an aqueous solution whose composition matches that of the mobile phase 124. Excess liquid is removed from the sides and back of the plate 10. A sample mixture to be separated is spotted onto a section of the monolithic polymer layer 18 with a micropipette (not shown), a microliter syringe (not shown), or any other appropriate spotting devices prior to pre-wetting the plate 10. The particular volume of sample mixture used may vary depending upon the type of sample, the particular apparatus used, and the particular application. For example, in one embodiment, sample sizes of about 0.3 microliters to about 5 microliters were used in embodiments wherein the dilute samples were peptides or proteins. However, other sample sizes may be used in other embodiments. For example, in embodiments wherein the monolithic polymer layer 18 is relatively thick, larger sample volumes may be used. Additionally, for some particular applications, a substantially smaller sample volume (e.g., 10 nanoliters) may be used.

The initial spot containing the sample mixture placed onto the monolithic polymer layer 18 of plate 10 may be kept as small as possible in some embodiments. In addition, the plate 12 may be pre-wetted such that the pre-wetted portion of the plate 12 is positioned within one millimeter of the initial spot. Note that spot 134, representing the initial spot of the sample mixture to be separated, is shown enlarged for clarity of description.

In the illustrative embodiment, the plate 10 is positioned relative to the mobile phase 124 such that the end 120 of plate 10 is located below the surface 126 of mobile phase 124 and the area of the monolithic polymer layer 18 with spot 134 disposed thereon is located above the surface 126 of mobile phase 124. It should be understood that a tank or reservoir may be used to hold the mobile phase 124. Additionally, it should be understood that in other embodiments the end 118 of the plate 10 may be located below the surface of or in contact with additional mobile phase, which may be held in the same or additional reservoir relative to the mobile phase 124. Further in some embodiments, a wicking material may be used to wick the mobile phase (or run buffer in embodiments utilizing electrophoretic mobility) from one or more reservoirs to the monolithic polymer layer 18.

As such, the anode 128 is electrically coupled to a power source 140 via electrical wire 142. In addition, the cathode 130 is electrically coupled to power source 140 via electrical wire 144. As discussed above, the monolithic polymer layer 18 is negatively charged in the illustrative embodiment of FIG. 4. As such, the anode 128 is placed in contact with mobile phase 124 and the cathode 130 is placed into contact with the plate 10. The cathode 130 may be urged into direct contact with the polymer monolithic layer 18 with a clamping mechanism, e.g. an electrically non-conducting clamp. Alternatively, in embodiments including a reservoir of mobile phase 124 at each end 118, 120 of the plate 10, the cathode 130 may be placed in contact with the additional mobile phase located at the end 118 of the plate 10. Again, in embodiments wherein the monolithic polymer layer 18 is positively charged, the positioning of the anode 128 and the cathode 130 may be swapped in embodiments wherein the mobile phase is positioned at a single end 118, 120 of the plate 10. In embodiments wherein the monolithic polymer layer 18 is neutral, the anode 128 and cathode 130 may be positioned in either configuration.

Once the cathode 130 and the anode 128 are positioned as described above and electrically coupled to the power source 140, an electrical potential is created between the cathode 130 and the anode 128 with the power source 140. It should be understood that, in one embodiment, the electrical potential is created between the cathode 130 and the anode 128 about 10 seconds to about 30 seconds after the end 120 of plate 10 is located below the surface 126 of mobile phase 124.

The magnitude of the electrical potential created with power source 140 is limited by the amount of current the power source 140 can tolerate, and by the ohmic heating which can cause plate 10 to dry out during the development thereof in those embodiments not including a coverplate over the chromatographic plate 10 (e.g., in those embodiments using atmospheric pressure). In addition, the magnitude of the electrical potential should be selected to reduce the likelihood of arcing to any nearby exposed metallic surface. For example, in one embodiment, the electrical potential generated by power source 140 can range from about 300 V to about 10,000 V, but other voltages may be used in other embodiments. One power source that may be used in the arrangement 100 is a model PS/EW15R109-CD11, which is commercially available from Glassman High Voltage, Incorporated of High Bridge, N.J.

Because the monolithic polymer layer 18 is negatively charged in the illustrative embodiment of FIG. 4, the mobile phase 124 is attracted to the cathode 130 when a potential is created between the anode 128 and cathode 130. As such, the mobile phase 124 is advanced through the monolithic polymer layer 18 in the direction of indicated by arrow 132 (i.e., toward the cathode 130). As mobile phase 124 is advanced toward the cathode 130, the components of the mixture contained within initial spot 134 partition between mobile phase 124 and the polymeric stationary phase based upon their differing physical and chemical characteristics. Since the components of the mixture contained within initial spot 134 will typically differ based upon their polarity, charge, and size they are separated from each other as the chromatographic plate 10 is developed.

An exemplary separation is depicted in FIG. 4. In particular, the mixture initially disposed onto monolithic polymer layer 18 of plate 10 as spot 134 is depicted as containing two components (i.e., spot 104 and spot 106). As shown in FIG. 4, utilizing the chromatography arrangement 100 as described above results in these two components being separated from each other along the longitudinal axis of the chromatographic plate 12. Once separated, the spots 104 and 106 can be detected or visualized with various techniques. For example, after development and drying, the spots 104, 106 may be visualized by scanning the chromatographic plate 12 with a suitable scanning densitometer. For example, one such scanner that can be used to visualize the spots 104, 106 is the model number CAMAG III scanning densitometer, which is commercially available from CAMAG Scientific Inc. of Wilmington, N.C.

It should be appreciated that separation of analytes described above is in reference to a chromatographic plate 10 including a negatively charged monolithic polymer layer 18. However, as discussed above, chromatographic plates 10 having a positively charged monolithic polymer layer 18 may also be used. In such embodiments, the anode 128 is positioned at the end 118 of the chromatographic plate 10 and the cathode 130 is positioned at the end 120 of the plate 10 as discussed above. As such, when a potential is created between the anode 128 and cathode 130, the mobile phase 124 is attracted to the anode 128 and is advanced through the monolithic polymer layer 18 toward the anode 128. Again, as mobile phase 124 is advanced toward the anode 128, the components of the mixture contained within the initial spot 134 partition between mobile phase 124 and the polymeric stationary phase based upon their differing physical and chemical characteristics.

In embodiments wherein the chromatographic plate 10 includes a negatively charged or positively charge monolithic polymer layer 18, the mobile phase 124 is advance through the layer 18 via electroosmotic flow. That is, the potential applied between the anode 128 and cathode 130 generates an electroosmotic flow of the mobile phase 124 through the monolithic polymer layer 18. In other embodiments, other force flow techniques in addition to planar electrochromatography (PEC) and pressurized planar electrochromatography (PPEC) may be used including, but not limited to, rotational planar chromatography (RPC) and overpressured layer chromatography (OPLC. In those embodiments wherein pressure above atmospheric pressure is used, a coverplate may be placed over the chromatographic plate 10 and the edges of the coverplate and the plate 10 may be sealed using a suitable sealant, gasket, and/or the like.

In addition to negatively charged and positively charged monolithic polymer layers 18, chromatographic plates 10 having neutral monolithic polymer layers 18 may be used as discussed above. In such embodiments, either or both ends 118, 120 of the plate 10 may be placed in contact with the mobile phase 124. Additionally, the anode 128 and cathode 130 may be positioned in any configuration (i.e., toward any one of the ends 118, 120) as discussed above. However, unlike embodiments including a negatively or positively charged monolithic polymer layer 18, there is no significant flow of the mobile phase 124. Rather, when a potential is created between the anode 128 and cathode 130, the analyte components are attracted to a particular electrode (i.e., the anode 128 and cathode 130) depending on the charge of the analyte. As the negatively charged analyte components advance toward the anode 128 and the positively charged analyte components advance toward the cathode 130, the components are separated across the monolithic polymer layer 18 based upon their differing physical and chemical characteristics. In such embodiments, the charged components of the analyte are advanced through the monolithic polymer layer 18 via electrophoresis. That is, the potential applied between the anode 128 and cathode 130 generates an electrophoretic mobility of the charged components through the monolithic polymer layer 18.

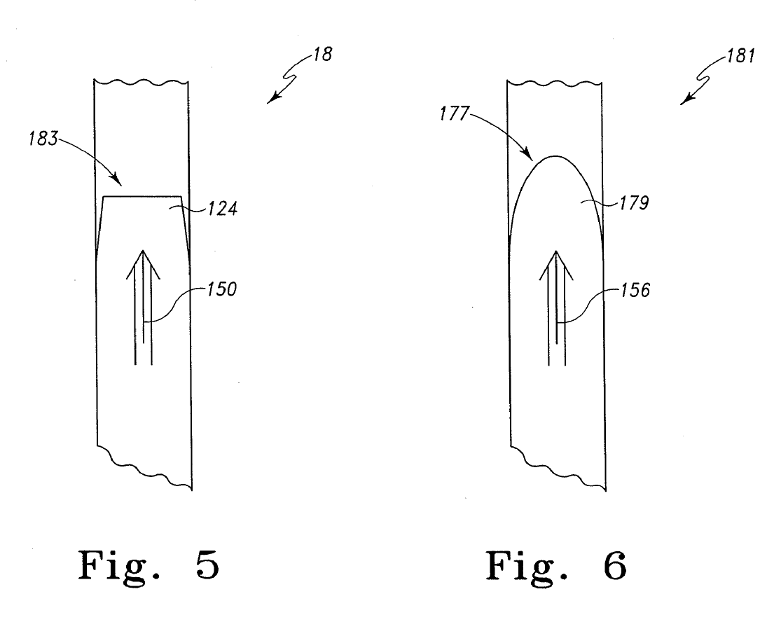

It should be appreciated that those embodiments utilizing electroosmotic flow (i.e., embodiments having charged monolithic polymer layers 18) may exhibit features different from chromatographic apparatuses that utilize capillary action or are pressure-driven. For example, as shown in FIG. 5, utilizing electroosmotic flow to advance mobile phase 124 through an idealized channel of the monolithic polymer layer 18 in the direction of arrow 150 results in the mobile phase 124 having a substantially plug-shaped flow profile 183. That is, as the mobile phase 124 flows through one of a number of channels defined in the monolithic polymer layer 18, the mobile phase 124 exhibits a substantially plug-shaped flow profile 183 with respect to the channel.

By establishing a plug flow profile, the cross-sectional velocity of the flow of the mobile phase remains relatively constant. The relatively constant cross-sectional velocity reduces zone broadening, which may substantially increase the separation efficiency of the chromatography arrangement 100 as compared to other chromatography arrangements that utilize pressure or capillary action to advance the mobile phase through the chromatographic bed. Specifically, chromatography arrangements which depend upon pressure to advance the mobile phase through the chromatographic bed result in the mobile phase having a laminar flow profile (i.e. parabolic flow profiles).

For example, in FIG. 6, there is shown a flow profile 177 of a mobile phase 179 being advanced through a channel of a chromatographic bed 181 in the direction indicated by arrow 156 with pressure. As previously mentioned, advancing a mobile phase through a chromatographic bed via pressure results in a laminar flow profile. In other words, the center portion of the liquid of mobile phase 179 flows faster than the liquid close to the channel wall is advanced through chromatographic bed 181. This laminar flow profile increases the contributions to zone broadening which substantially decreases the separation efficiency of such pressure driven chromatography arrangements. Moreover, having pressure driven mobile phase results in the migration characteristics of the mobile phase being sensitive to (i) the particle size, (ii) the particle size distribution of the stationary phase and (iii) the length of the chromatographic bed. Additionally, advancing a mobile phase through a chromatographic bed via capillary action results in similar characteristics.

Furthermore, those embodiments using electroosmotic flow to advance a mobile phase through a charged monolithic polymer layer 18 have several additional features different from advancing a mobile phase through a chromatographic bed via capillary action or pressure. Additionally, the length of the chromatographic beds (e.g., the monolithic polymer layer 18) of arrangements utilizing electroosmotic flow may be increased relative to those chromatographic beds used with capillary action arrangements. That is, the length of the chromatographic bed is not a significant limiting factor in improving separation because the decrease in linear velocity with distance traveled will no longer be an issue as in capillary mediated chromatography arrangements. As such, there is no theoretical limit to the length of the charged monolithic layer in such embodiments.

Several particular experiments using monolithic polymer layers will now be discussed. In one illustrative experiment, a positively charged monolithic polymer layer 18 (i.e., a layer including [2-(methacryloyloxy)ethyl]trimethylammonium chloride) having a 700 nanometer pore size was used in an electrochromatographic apparatus similar to the arrangement 100 described above. In this experiment, a 50% aqueous acetonitrile solution containing 5 mM phosphate buffer at a pH level of about 7.0 was used as the mobile phase. A myoglobin sample was applied to the positively charged monolithic polymer layer 18. A pressure of about 39 atmospheres was applied against the monolithic polymer layer 18 and a two kilovolt potential was applied across the plate 10 for about twelve minutes. In response, the myoglobin migrated across the monolithic polymer layer 18 about 35 millimeters and had a final spot width of about 3.5 millimeters.

In another illustrative experiment, a negatively charged monolithic polymer layer 18 (i.e., a layer including 2-acrylamido-2-methyl-1-propanesulfonic acid) having a 700 nanometer pore size was used in an electrochromatographic apparatus similar to the arrangement 100 described above. In this experiment, a 30% aqueous acetonitrile solution containing 5 mM phosphate buffer at a pH level of about 8.0 was used as the mobile phase. Several different samples were applied to the negatively charged monolithic polymer layer 18. Specifically, an enkephalin sample, an oxytocin sample, and an angiotensin II sample were applied. A pressure of about 39 atmospheres was applied against the monolithic polymer layer 18 and a 2.5 kilovolt potential was applied across the plate 10 for about seven minutes. In response, the enkephalin migrated across the monolithic polymer layer 18 about 5 millimeters and had a final spot width of about 1.8 millimeters. The oxytocin migrated across the monolithic polymer layer 18 about 6 millimeters and had a final spot width of about 2 millimeters. Additionally, the angiotensin II migrated across the monolithic polymer layer 18 about 5 millimeters and had a final spot width of about 1 millimeters.

In yet another illustrative experiment, a neutral monolithic polymer layer 18 (i.e., a layer comprising poly(butyl methacrylate-co-ethylene dimethacrylate) having a 700 nanometer pore size was used in an electrochromatographic apparatus similar to the arrangement 100 described above. In this experiment, a 30% aqueous acetonitrile solution containing 5 mM phosphate buffer at a pH level of about 2.0 was used as the run buffer. Several different samples were applied to the neutral monolithic polymer layer 18. Specifically, an enkephalin sample, an angiotensin II sample, a lysozyme sample, and an insulin sample were applied. A pressure of about 39 atmospheres was applied against the monolithic polymer layer 18 and a two kilovolt potential was applied across the plate 10 for about 2.5 minutes. In response, the enkephalin migrated across the monolithic polymer layer 18 about 12.5 millimeters and had a final spot width of about 1.4 millimeters. The angiotensin migrated across the monolithic polymer layer 18 about 4 millimeters and had a final spot width of about 1.9 millimeters. The lysozyme migrated across the layer 18 about 6 millimeters and had a final spot width of about 1.8 millimeters. Additionally, the insulin migrated across the monolithic polymer layer 18 about 2 millimeters and had a final spot width of about 2 millimeters.

While the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired to be protected.

There are a plurality of advantages of the present disclosure arising from the various features of the apparatus and methods described herein. It will be noted that alternative embodiments of the apparatus and methods of the present disclosure may not include all of the features described yet still benefit from at least some of the advantages of such features. Those of ordinary skill in the art may readily devise their own implementations of an apparatus and method that incorporate one or more of the features of the present disclosure and fall within the spirit and scope of the present disclosure.

1. A method for performing chromatography, the method comprising:
placing a monolithic polymer layer in contact with a liquid mobile phase;
coupling a first electrode to the monolithic polymer layer;
coupling a second electrode to the monolithic polymer layer; and
creating an electrical potential between the first electrode and the second electrode.

2. The method of claim 1, wherein placing the monolithic polymer layer in contact with the liquid mobile phase comprises placing a first end and a second end of the polymer monolithic layer in contact with the liquid mobile phase.

3. The method of claim 1, wherein placing the monolithic polymer layer in contact with the liquid mobile phase comprises placing a charged monolithic polymer layer in contact with the liquid mobile phase.

4. The method of claim 3, wherein placing the monolithic polymer layer in contact with the liquid mobile phase comprises placing a positively charged monolithic polymer layer in contact with the liquid mobile phase.

5. The method of claim 3, wherein placing the monolithic polymer layer in contact with the liquid mobile phase comprises placing a negatively charged monolithic polymer layer in contact with the liquid mobile phase.

6. The method of claim 1, wherein coupling the second electrode to the monolithic polymer layer comprises contacting the second electrode to a mobile phase in contact with monolithic polymer layer.

7. The method of claim 1, wherein creating an electrical potential between the first electrode and the second electrode comprises creating an electrical potential between the first electrode and the second electrode to cause the liquid mobile phase to be advanced through a charged monolithic polymer layer.

8. The method of claim 6, wherein the liquid mobile phase is advanced through the charged monolithic polymer layer via electroosmotic flow.

9. The method of claim 1, wherein placing the monolithic polymer layer in contact with the liquid mobile phase comprises placing a neutral monolithic polymer layer in contact with the liquid mobile phase.

10. The method of claim 9, wherein creating an electrical potential between the first electrode and the second electrode comprises creating an electrical potential between the first electrode and the second electrode to cause an analyte positioned in the monolithic polymer layer to advance through the monolithic polymer layer via electrophoresis.

11. The method of claim 1, further comprising placing the polymer monolithic layer in a sealed chamber.

12. The method of claim 11, further comprising increasing the pressure inside the sealed chamber relative to the pressure outside the sealed chamber.

13. The method of claim 11, further comprising maintaining the pressure inside the sealed chamber at a pressure above atmospheric pressure.

14. The method of claim 1, further comprising exerting an amount of pressure on the monolithic polymer layer greater than atmospheric pressure.

15. The method of claim 1, further comprising maintaining the temperature of the monolithic polymer layer at a predetermined temperature.

16. A method for performing chromatography, the method comprising:
placing a monolithic polymer layer in contact with a liquid mobile phase; and
advancing the liquid mobile phase through the monolithic polymer layer via a forced flow technique.

17. The method of claim 16, wherein the forced flow technique is selected from the group consisting of: rotational planar chromatography, overpressurized layer chromatography, planar electrochromatography, and pressurized planar electrochromatography.

18. A chromatographic bed for use in chromatography, the chromatographic bed comprising a monolithic polymer layer having a plurality of ionizable functionalities.

19. The chromatographic bed of claim 18, wherein the monolithic polymer layer is positively charged.

20. The chromatographic bed of claim 18, wherein the monolithic polymer layer is negatively charged.
